(19) United States
(12) Patent Application Publication
(10) Pub. No.: US 2005/0270468 A1
(43) Pub. Date: Dec. 8, 2005

(54) Liquid crystal display device and manufacturing method thereof

(76) Inventors: Tae-Young Choi, Seoul (KR); Sang-Il Kim, Gyeonggi-do (KR)

Correspondence Address: CANTOR COLBURN, LLP, 55 GRIFFIN ROAD SOUTH, BLOOMFIELD, CT, 06002, US

(21) Appl. No.: 11/115,730

(22) Filed: Apr. 27, 2005

(30) Foreign Application Priority Data
May 31, 2004 (KR) 10-2004-0038997

(51) Int. Cl. G02F 1/1339

(52) U.S. Cl. 349/155

(57) ABSTRACT

A display panel for a liquid crystal display device comprises two substrates facing each other and having a gap therebetween, electrodes to establish an electric field in a space between the two substrates, spacers disposed between the two substrates to allow the two substrates to have the gap therebetween, and a liquid crystal layer disposed between the two substrates. The display panel further comprises a polarizer disposed on an outer surface of each substrate, and another spacers disposed between the substrate and the polarizer to provide a uniform gap therebetween. The spacers are each coated with a polymerization initiator before being disposed between the substrates or between the substrate and the polarizer so that polymer is formed around the spacers.

The present application claims priority from Korean Patent Application No. 2004-38997, filed on May 31, 2004, the contents of which is incorporated by reference in its entirety.

### BACKGROUND OF THE INVENTION

1. Field of the Invention

The present invention relates to an image display device, and more particularly to a display panel for liquid crystal display devices and a method of manufacturing the display panel.

2. Description of the Related Art

Commercially, it is highly desirable for an electronic display device to be as thin and light as possible while still maintaining a high degree of ruggedness and imperviousness to forces that are a consequence of shock or drop. In the area of mobile electronics, such as cell phones and personal digital assistants (PDAs), size and weight are critical factors to the commercial success of a product, but currently breakage of the display devices within these devices remains the primary cause of repairs and product returns. In addition, the need for electronic display devices that can actually be bent has been acknowledged in several areas: so-called ‘electronic paper’ in which fiber paper is replaced with a display device would be much more compelling as a product if the electronic display device could be rolled up or folded like traditional paper; wearable electronics such as computers or multifunction watches would be much more comfortable to the wearer if the display means were to conform to the user's body; and chip cards which have strict flexure life-test performance standards would be able to incorporate flexible display means and still conform to those standards.

Replacement of the glass substrates within a display device with plastic films has been an area of active research within the display community such as electro-phoretic displays, Cholesteric displays, and Gyricon displays being developed by Xerox® for a number of years.

Liquid crystal display (LCD) devices are attractive because of the low drive voltages required to switch them, their relatively fast response times, the wide availability of drive electronics, and the significant intellectual and manufacturing investment in the technology.

Attempts have been made to develop LCD devices that intermix liquid crystal within a polymer matrix in order to make them compatible with plastic substrates. Polymer dispersed LCD (PDLCD) devices, one example of the LCD devices, are fabricated by intermixing the liquid crystal and a pre-polymer into a solution prior to assembling the display. After assembling the display, the polymer is cured, typically by ultraviolet light. During the polymerization, the liquid crystal separates out from the polymer into microscopic droplets. Since the droplets of liquid crystal are not in contact with any alignment layer, orientation of the liquid crystal molecules is random and light is scattered by the droplets. Applying a voltage to the electrodes of the PDLCD device causes the liquid crystal molecules to become aligned, resulting in the display device becoming transparent.

However, like the other flexible display devices, PDLCD devices require high drive voltages not generally compatible with existing drive electronics. Prior art such as U.S. Pat. Nos. 4,688,900, 5,321,533, 5,327,271, 5,434,685, 5,504,600, 5,530,566, 5,583,672, 5,949,508, 5,333,074, and 5,473,450 all make use of phase separation of an liquid crystal and polymer mixture during polymerization of the polymer using light as the curing mechanism (photopolymerization).

Developing flexible display devices using plastic as a substrate is not without its problems. For example, the multi-layered structure of such display devices diminishes its flexible capabilities. The flexibility feature of display devices is maintained by an injection step during the LCD manufacturing process, but is rapidly decreased after attaching the polarizers.

### SUMMARY OF THE INVENTION

The above mentioned and other drawbacks and deficiencies of the prior art are overcome or alleviated by a liquid crystal display device and a manufacturing method thereof according to the present invention.

In one embodiment, a display device of the present invention includes spacers, on which polymer is coated, disposed between a substrate and a polarizer to support and combine the substrate and the polarizer.

A liquid crystal display is provided, which includes two substrates facing each other and having a predetermined gap therebetween, field-generating electrodes to form an electric field between the two substrates, first spacers disposed between the two substrates to allow the two substrates to have the predetermined gap therebetween, a liquid crystal layer disposed between the two substrates, a polarizer disposed on an outer surface of at least one of the two substrates, and second spacers disposed between the polarizer and the at least one of the two substrates to allow the polarizer and the at least one of the two substrates to have a uniform gap therebetween.

The display panel may also include a first polymer disposed around the first spacers to provide adhesion between the two substrates. The display panel may also include a second polymer disposed around the second spacers between the polarizer and the at least one of the two substrates to provide adhesion between the polarizer and the at least one of the two substrates. A medium may be filled between the two substrates and between the polarizer and the at least one of the two substrates. The display panel may also include a sealant to seal surrounding regions of a space between the polarizer and the at least one of the two substrates, in which the second spacers, the second polymer and the medium are contained. The first and second spacers may be spherical or column, and have elasticity. The first and second spacers may include plastic, and comprise high-surface area particles that are nanoporous, mesoporous, or microporous.

### BRIEF DESCRIPTION OF THE DRAWINGS

The present invention will become more apparent by describing embodiments thereof in detail with reference to the accompanying drawings in which:

FIG. 1 shows a cross section of a display panel having spherical spacers coated with a photoinitiator prior to exposure to light;

FIG. 2 shows a cross section of a display panel that uses spherical spacers coated with a photoinitiator after exposure to light;

FIG. 3 shows a cross section of a display panel that uses spherical spacers coated with an accelerator after polymerization and exposure to light;

FIG. 4 shows a cross section of a display panel that uses a mesh-like spacing membrane;

FIG. 5 shows a cross section of a display panel that uses spherical spacers coated with a photoinitiator and non-structural polymer initiation or enhancement (PIE) elements prior to exposure to light;

FIG. 6 shows a cross section of a display panel that uses spherical spacers coated with a photoinitiator and non-structural polymer initiation or enhancement (PIE) elements after exposure to light;

FIG. 7 shows a cross section of a display panel with an adhesion of polarizers by using spherical spacers coated with polymer initiation; and

FIG. 8 shows a cross section showing transformation of the spherical spacers coated with the polymer initiation by shear stress in the display panel.

### DETAILED DESCRIPTION OF THE INVENTION

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films, and regions have been exaggerated for purposes of clarity. Like numerals refer to like elements throughout. It will be understood that when an element such as a layer, film, region or substrate is referred to as being “on” another element, it will be construed as being either directly on the other element or that intervening elements may also be present. In contrast, when an element is referred to as being “directly on” another element, it will be construed such that there are no intervening elements present.

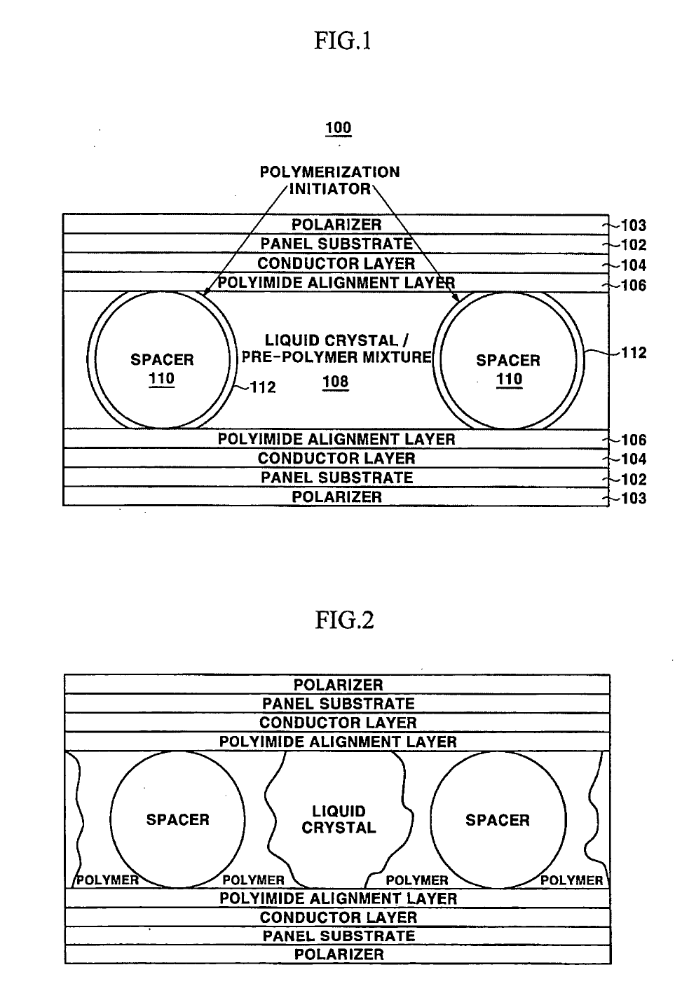

Referring to FIG. 1, a liquid crystal display (LCD) device and an assembly process thereof according to an exemplary embodiment of the present invention will now be described. In FIG. 1, provided is a cross-sectional view of a display panel 100 of an LCD device according to an exemplary embodiment of the present invention. The display panel 100 includes substrates each having a flexible polymer material with a low level of birefringence to improve the optical quality of the LCD device. In this embodiment, each substrate includes a panel substrate 102 comprising the flexible polymer material. Owing to such properties of the substrates, the display panel 100 also has flexible properties, which also renders the LCD device flexible. The flexible polymer material may have a glass transition temperature greater than about 150 Celsius degrees in order to facilitate the various drying and baking operations. A polymer that meets these requirements is, for example, poly ether sulphone (PES). A vapor barrier may be coated onto the outside surface of the respective substrates to improve the reliability and product life of the display device. The vapor barrier is typically composed of a thin film laminate structure of silicon oxide and another polymer.

The display panel 100 may also include a polarizer 103 to control the amount of light passing through the substrates. The polarizer 103 may be disposed on the outer surface of at least one of the substrates. In the display panel 100 of this embodiment, each substrate has the polarizer 103 disposed on the outer surface of the panel substrate 102.

The substrates are each coated with a conductor layer 104 by using, for example, a vacuum-deposition method. The conductor layer 104 of this embodiment is made of indium tin oxide (ITO), which is a transparent conductor. The conductor layer 104 is then patterned via chemical, electron beam, or laser etching process or a combination thereof.

A polyimide solution is coated on the inner surface of each of the conductor layers 104. The polyimide solution is baked at a temperature of about 150 Celsius degrees for about an hour. A polyimide surface formed on the inner surface of each conductor layer 104 is then rubbed to develop a polyimide alignment layer 106 for liquid crystal.

A mixture 108 is prepared of about 10% photoinitiated pre-polymer, for example, Norland Products NOA-65, and about 90% liquid crystal, for example, Merck E7. The pre-polymer formulation has been modified such that substantially all photoinitiators are removed from the formulation. The liquid crystal and pre-polymer mixture 108 is disposed between the substrates, in particular, between the inner surfaces of the polyimide alignment layers 106.

Spaces 110 are disposed in the liquid crystal and pre-polymer mixture 108 between the substrates. The spaces 110 are made of, for example, glass, and each may have a diameter of about 3-3.5 μm. The glass spacers 110 are surface-etched using a hydrofluoric acid solution while being suspended in a solution within an ultrasonic vibration tank. For example, the hydrofluoric acid solution is a solution of about 1.25% hydrofluoric acid, and the surface-etching is performed for about 10 minutes. After being washed, the etched spacers 110 are coated with a photoinitiator layer 112, for example, a mixture of methacrylate silane and a photoinitiator by immersing the spacers 110 into a solution containing the initiator and an adhesion promoter such as silane. The spacers 110 are sprayed onto the inner surface(s) of one of or both the substrates. The silane improves adhesion between glass and polymer via chemical bonding at the silane/glass interface and dispersion of the polymer into the silane at the silane/polymer interface.

The spacers 110 are deposited onto the polyimide alignment layer(s) 106 with a density of about 30 spacers/mm² or more. The spacers 110 may be distributed in a random fashion across the inner surface(s) of the substrates.

The liquid crystal and pre-polymer mixture 108 is deposited in sufficient quantity between the inner surfaces of the substrates, and the substrates are laminated together while maintaining a proper alignment of ITO patterns in the conductor layers 104.

Both sides of the display panel 100 are then exposed to UV light that causes scission of the photoinitiator from the photoinitiator layer 112 and release of free radicals around the spacers 110. The polymerization reaction will then proceed with initiation sites around each spacer 110.

The rate of polymerization may be determined at the beginning of the process by adjusting the UV light intensity. The rate of diffusion of the liquid crystal and pre-polymer is changed by adjusting the reaction temperature. The diffusion rate can also be controlled by adjusting viscosity of the pre-polymer and/or adjusting a degree of miscibility of the liquid crystal and pre-polymer. By adjusting the diffusion rate and the reaction rate, the resulting liquid crystal and polymer structure can provide a desired morphology. For full phase separation, the reaction temperature is equal to or higher than about 45 Celsius degrees and the pre-polymer viscosity is less than about 1000 cps.

The display panel 100 resulting from the process described above is shown in FIG. 2. The display panel 100 is flexible and, thus, a display device having the display panel 100 may be flexed without damage by at least the amount of flexing specified in the flexing tests described in U.S. Pat. No. 6,019,284, the contents of which is incorporated by reference herein in its entirety.

It will be understood that it is not necessary that the polymer forms in the vicinity of each spacer, nor that the polymer extends fully from one substrate to the other in all cases. Some spacers, for example, may not have been coated with polymer initiation or enhancement (PIE) material, or they may have been imperfectly coated.

Polymer supports that do not extend fully from one substrate to the other may still be of benefit in creating isolated regions of liquid crystal, and thereby make possible improved bistability of certain ferroelectric liquid crystal materials, which may exhibit improved bistability if the liquid crystal layer is divided into discrete droplets along one substrate.

In an alternative embodiment, the polymerization initiator is an ‘accelerator lacquer’ type initiator instead of the photoinitiator. The polymerization initiator of this embodiment is thus not activated by light. When using the accelerator lacquer type initiator, coating the spacers is accomplished via the method as previously described, but the polymerization begins to occur automatically at some time after the liquid crystal and polymer mixture is brought into contact with the initiator-coated spacers. Lamination is performed at room temperature in order to lengthen the time before cure begins. After lamination has been completed, the temperature is raised in order to increase the diffusivity of the liquid crystal and pre-polymer. In addition, the aromatic amines in the pre-polymer formulation and the peroxide in the lacquer are chosen so as to provide the correct free radical generation rate which, when combined with the diffusion rates of the pre-polymer and liquid crystal and the spacings within the display region, result in the polymer localized to the region surrounding the spacers.

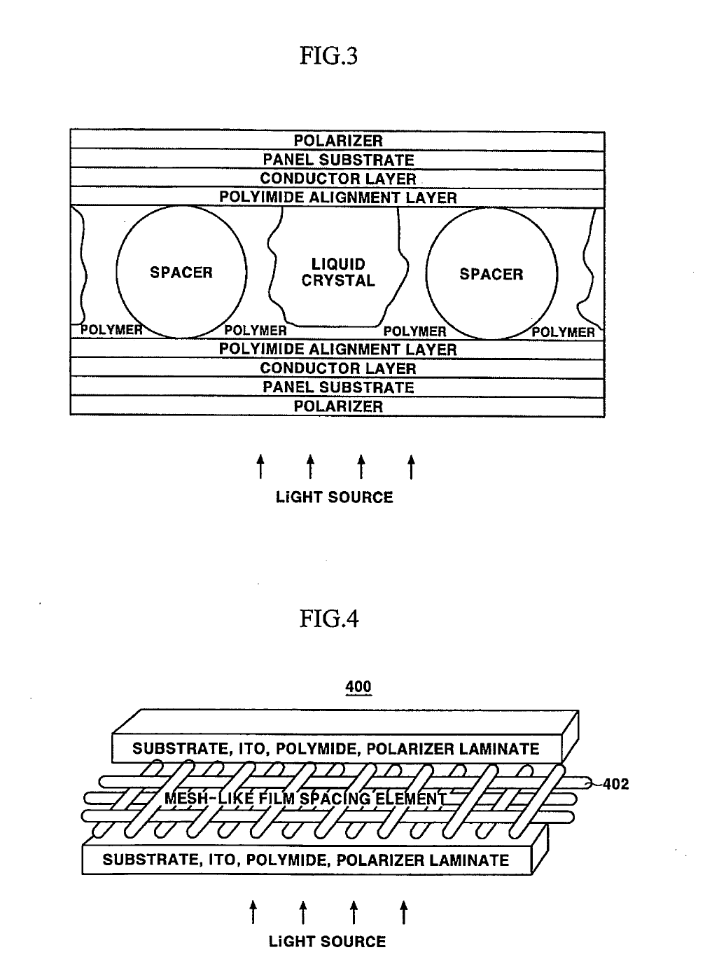

In another embodiment, the pre-polymer formulation retains its photoinitiator component but the spacers are still coated with an adhesion promoter such as a silane coating along with an accelerant or additional photoinitiator. Typical active ingredients in the accelerant would be a tertiary amine like dimethyl amino benzene. The curing in this case will be initiated by both the accelerant and the light. The accelerant reaction is allowed to proceed for a sufficient period of time to localize most of the polymer around the spacers. A light source is then turned on to irradiate one side (in this embodiment, only one side) of the display panel 100, resulting in a deposition of any of the remaining polymer along the substrate closest to the light source as shown in FIG. 3.

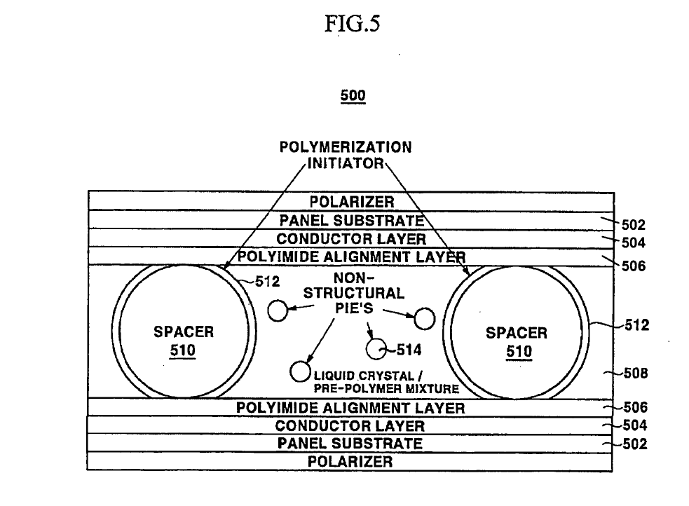

This particular embodiment can be further refined by using liquid crystal capable of bistability, i.e., the ability to maintain two or more electrooptic states without any electric field being present. Some examples of such a bistable or multistable liquid crystal are those of the ferroelectric or anti-ferroelectric type liquid crystal. In a further refinement, the reaction rate is varied during the course of polymerization to create a structure in which liquid crystal droplets interspersed in the polymer are created on the alignment surface of the substrate nearest to the light source. As a result, a thin layer of the liquid crystal is created on the alignment surface of the substrate opposite the light source as shown in FIG. 4. Both the alignment surfaces are aligned in such a configuration so as to produce alignment of the liquid crystal molecules on both the surfaces. Droplet-encapsulated liquid crystal is more durable in terms of maintaining bistability.

The spacer element may be one or more sheets of an extensible porous membrane. In the display panel 400 of FIG. 4, for example, the spacer element is a mesh-like film spacing element 402. When being laminated between the substrates, the mesh-like film spacing element 402 determines the gap between the substrates.

Referring to FIG. 5, a liquid crystal display device and an assembly process thereof will be described in accordance with another exemplary embodiment. A display panel 500 for an LCD device includes the substrates having a flexible polymer material with a low level of birefringence to improve the optical quality of the LCD device. In this embodiment, the substrates of the display panel 500 each include a panel substrate 502 that comprises the flexible polymer material. The flexible polymer material has a glass transition temperature, for example, greater than about 150 Celsius degrees in order to facilitate the various drying and baking operations. A polymer which meets these requirements is, for example, poly ether sulphone (PES). A vapor barrier may be coated onto the outside surface of the respective panel substrates 502 to improve the reliability and product life of the display device. The vapor barrier may be composed of a thin film laminate structure of silicon oxide and another polymer.

The panel substrates 502 are coated with a conductor layer 504 by using, for example, a vacuum-deposition process. The conductor layer 504 comprises, for example, indium tin oxide (ITO), which is a transparent conductor. The conductor layer 504 is then patterned via chemical, electron beam, or laser etching process.

A polyimide solution is coated on the inner surface of each of the conductor layers 504. The polyimide solution is baked at a temperature of about 150 Celsius degrees for about an hour. A polyimide surface formed on the inner surface of each conductor layer 504 is then rubbed to develop a polyimide alignment layer 506 for liquid crystal.

A mixture 508 is prepared of about 10% photoinitiated pre-polymer, for example, Norland Products NOA-65, and about 90% liquid crystal, for example, Merck E7. The pre-polymer formulation has been modified such that substantially all photoinitiators are removed from the formulation. The liquid crystal and pre-polymer mixture 508 is disposed between the substrates, in particular, between the inner surfaces of the polyimide alignment layers 506.

Spacers 510 are disposed in the liquid crystal and pre-polymer mixture 508 between the substrates. The spacers 510 are made of, for example, glass, and each may have a diameter of about 3-3.5 μm.

The glass spacers 510 are surface-etched using a hydrofluoric acid solution while being suspended in a solution within an ultrasonic vibration tank. For example, the hydrofluoric acid solution is a solution of about 1.25% hydrofluoric acid, and the surface-etching is performed for about 10 minutes. After being washed, the etched spacers 510 are coated with a photoinitiator layer 512, for example, a mixture of methacrylate silane and a photoinitiator by immersing the spacers 510 into a solution containing the initiator and an adhesion promoter such as silane. The spacers 510 are sprayed onto the inner surface(s) of one of or both the substrates. The silane improves adhesion between glass and polymer via chemical bonding at the silane/glass interface and dispersion of the polymer into the silane at the silane/polymer interface.

The spacers 510 are deposited onto the polyimide alignment layer(s) 506 with a density of about 30 spacers/mm² or more.

PIE elements 514 are added to the liquid crystal and pre-polymer mixture 508. In this embodimnent, the PIE elements 514 each have a size of about 25% of that of the spacers 510 and a cross-sectional density approximately twice that of the spacers 510. The PIE elements 514 of this embodiment are non-structural PIE material.

The liquid crystal and pre-polymer mixture 508 is deposited in sufficient quantity between the inner surfaces of the substrates, and the substrates are laminated together while maintaining a proper alignment of ITO patterns in the conductor layers 504.

Both sides of the display panel 500 are then exposed to UV light, which causes scission of the photoinitiator from the photoinitiator layer 512 and release of free radicals around the spacers 510. The polymerization reaction will then proceed with the initiation sites around each spacer 510 or each PIE element 514.

The rate of polymerization may be determined at the beginning of the process by adjusting the UV light intensity. The rate of diffusion of the liquid crystal and pre-polymer is changed by adjusting the reaction temperature. The diffusion rate can also be controlled by adjusting viscosity of the pre-polymer and/or adjusting a degree of miscibility of the liquid crystal and pre-polymer. By adjusting the diffusion rate and the reaction rate, the resulting liquid crystal and polymer structure can be engineered to achieve a desired morphology. For full phase separation, the reaction temperature is equal to or higher than about 45 Celsius degrees and the pre-polymer viscosity is less than about 1000 cps.

If the non-structural PIE (NSPIE) elements 514 are each larger than about 50% of the spacer size, they will be distributed on a two-dimensional, random lattice network. Upon polymerization, the polymer will grow from the PIE's 514 in an approximately spherical shape, which with sufficient polymerization will extend onto the top surface of the substrate. As a result, localized polymer attachment is formed between the substrates.

In case that the NSPIE elements 514 are each smaller than 50% of the spacer size, or if the NSPIE elements 514 are mixed into the liquid crystal and pre-polymer mixture 508 prior to the display assembly, the NSPIE lattice network becomes three-dimensional.

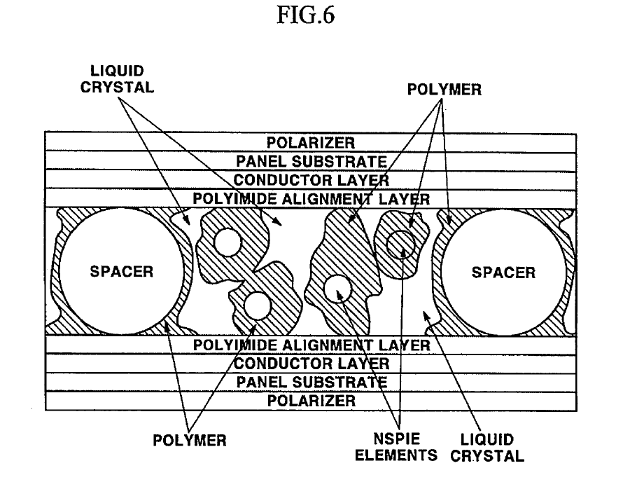

In case that the NSPIE elements 514 are each approximately 25% of the spacer size and a lattice network spacing is approximately 50% of the spacer diameter, an open-celled, integral network of polymer spheroids is formed with the liquid crystal filling the interpolymer regions as shown in FIG. 6. This structure is useful for a bistable display in that it provides a high density of mechanical discontinuities that increase optical hysteresis necessary for bistability, as well as added durability. In these lattice network structures, few NSPIE elements extend to both the substrates; some NSPIE elements contact one or the other substrate, and some NSPIE elements contact neither of the substrates.

In an alternative embodiment, the polymerization initiator is an ‘accelerator lacquer’ type initiator instead of the photoinitiator. The polymerization initiator of this embodiment is thus not activated by light. When using the accelerator lacquer type initiator, coating of the spacers or NSPIE elements is accomplished via the method as previously described, but the polymerization begins to occur automatically at some time after the liquid crystal and polymer mixture 508 is brought into contact with the initiator-coated spacers or NSPIE elements. Lamination is performed at room temperature in order to lengthen the time before cure begins. After lamination has been completed, the temperature is raised in order to increase the diffusivity of the liquid crystal and the pre-polymer. In addition, the aromatic amines in the pre-polymer formulation and the peroxide in the lacquer are chosen so as to provide the correct free radical generation rate which,- when combined with the diffusion rates of the pre-polymer and liquid crystal and the spacings within the display region, result in the polymer localized to the region surrounding the spacers or NSPIE elements.

The NSPIE elements 514 may be glass or plastic spheres or rods typically used in display devices. In this embodiment, the NSPIE elements 514 each have a size smaller than that of the spacers 510. Because the NSPIE elements are only in contact with, at most, one substrate, the NSPIE elements are not pressed against both the substrates with excessive force during compression. As a result, the NSPIE elements may have non-smooth shapes without causing damage to the surfaces of the substrates during compression. In addition, because the NSPIE elements are not used for spacing the substrates apart from each other, they may have various shapes and sizes and still perform their function satisfactorily. These factors allow for the use of a much wider variety of materials for the NSPIE elements than would be possible for the spacers. For instance, a new class or material, termed nanoporous material, is becoming available in which the pore size as well as total surface area can be specified and fabricated. This material may be ceramic or silica composite formed by sintering, aerosol methods, or by chemical treatment of preexisting minerals or glass. In most cases, however, since the resulting particles have poorly controlled size and/or shape and often a rough and sometimes sharp surface, they are not appropriate for the spacers in the display devices. For the NSPIE elements, however, the porosity of nonporous material can be controlled to provide a relatively predetermined volumetric reservoir of photoinitiator, accelerator or other polymerization enhancement component. For instance, when working with accelerants or photoinitiators, it is necessary that these components be present in a concentration of about 0.1-5% of the total pre-polymer in a display device. That concentration can be achieved by adjusting the size, number and porosity of the NSPIE elements.

The NSPIE elements may also be deposited directly onto the substrates prior to assembly. This may be done in conjunction with the NSPIE elements mixed into the liquid crystal and pre-polymer mixture and would provide stronger bonding of the polymer to the substrates.

Two or more photoinitiators with different spectral sensitivities may be used to control when polymerization is initiated at a particular site. Since scission of the photoinitiator occurs when the photon energy of a light source exceeds a certain threshold, photoinitiators are sensitive to light of a wavelength shorter than a specific value. Thus, a photoinitiator sensitive to the visible light is also sensitive to the ultraviolet light. In an embodiment using this feature, the spacer elements are coated with a visible light sensitive photoinitiator and the NSPIE elements are coated with a UV sensitive photoinitiator. The assembly is first exposed to the visible light, resulting in the curing of only the polymer around the spacers. The assembly is then exposed to UV light, causing curing of any additional pre-polymer still in solution with the liquid crystal.

In another embodiment, other polymerization enhancing compounds such as adhesion promoters, or additives such as urethanes which improve elongation before tear properties are added to all, or some subset, of the NSPIE elements. The NSPIE elements deposited on the substrates may have an additive that improves elongation before tear but decreasing the material's durometer (thus making it more susceptible to compression), while the NSPIE elements mixed into the liquid crystal and pre-polymer mixture may not have such an additive and thus be of a higher durometer. In such a way, peel strength can be further enhanced.

One possible polymer is acrylic adhesives which have excellent optical clarity as well as the availability of a wide selection of manufactured optical grade versions of the material. Other polymers that may also be used are, for instance, epoxies or urethanes, though these classes of polymers do not have the optical properties equal to those of the acrylics. Acrylic adhesives are reactive cross-linking structural adhesives that cure by means of free-radical initiation. They are based on the methacrylate monomers and cure by addition polymerization. The formation of free radicals initiates a sudden and rapid chain reaction and curing of the adhesive. Condensation polymerization, on the other hand, typified by urethane and epoxies, proceeds at an approximately constant, usually lower reaction rate. Generation of free radicals for initiation of polymerization of acrylic based adhesives can be accomplished by a redox reaction such as that involving dimethyl aniline and peroxide.

Because of the nature of the chain reaction, the free radicals can propagate from monomer to monomer and the cure itself can propagate up to about 2.5 mm from the point of polymerization initiation. As a result of this cure propagation phenomenon, the accelerator and monomer do not have to be fully intermixed to achieve a full cure. This leads to several other methods for curing, where the accelerator can be in the form of a lacquer or a thin layer on one surface allowing for the priming and storing of parts. In another related cure method termed ‘honeymoon’ or ‘no-mix’ in industry parlance, a two part adhesive is used which when brought into contact with each other (without any intermixing necessary) will result in the generation of sufficient free radicals to fully polymerize all the material.

Acrylics can also be cured by exposure to ultraviolet light of which wavelength is shorter than about 400 nm, and in some instances by light in the visible range as well. In the case of photocurable adhesives, the free radical source is termed a photoinitiator and results in the formation of free radicals on exposure to light. Compounds which act as photoinitiators with light in the wavelength range of about 200-300 nm are benzoine ethers, activated benzophenones and related compounds. Benzyl dialkyl amino morpholinyl ketone is an example of a visible wavelength-activated photoinitiator. Photoinitiators are disassociated into segments forming free radicals by light in a process known as scission. One example of an equal mix curing system is embodied in U.S. Pat. No. 4,331,795 which uses a cobalt salt accelerator in one component and a hydroperoxide in the other element. Epoxies may also be formulated that can be UV-cured via cationic polymerization by incorporating reactive diluents and cyclic monomers. UV-initiated cationic curing of urethanes may be accomplished, for instance, by basing the formation on vinyl ether and polyurethane oligomers such as that manufactured by Allied Signal, Inc.

A great variety of embodiments of the invention may be practiced. The PIE material may supply a constituent component of the pre-polymer that is essential to the initiation of curing but that is left out of the liquid crystal and pre-polymer mixture. That essential constituent is part of the PIE material and is deposited at one or more of the desired spacing elements within the display region, thus ensuring that initiation and cure will proceed from the desired locations only. The essential constituent component may be a photoinitiator which is activated when exposed to either UV or visible light via scission.

The rate of photopolymerization may be controlled by adjusting the intensity of the light source. The rate of diffusion of the phase separation process may be controlled by adjusting the temperature at which the reaction occurs. The rate of the photopolymerization may be varied during the course of the polymerization process in order to create multilayer, composite polymer and liquid crystal structures. The rate of the phase separation may be controlled by adjusting the miscibility of the liquid crystal and the pre-polymer. The rate of the phase separation may be controlled by adjusting the absolute and relative viscosities of the liquid crystal and/or the pre-polymer.

The spacer elements may be coated with an accelerator lacquer initiator or photoinitiator prior to device assembly and then dry-spray deposited onto one or more of the substrates. The spacer elements may be deposited via a wet-spray method in which a solution used as the deposition vehicle is either strictly composed of an accelerator or photoinitiator, or includes either or both of these compounds and a solvent, the concentration of which is adjusted to achieve the appropriate quantity of material to fully polymerize the pre-polymer within the display region around the spacers. The spacers may be mixed into a solution of the accelerator or photoinitiator. The solution is then dispensed in liquid form, via a method such as a pipette, silk screen or syringe, directly onto macroscopic regions on the substrates. The macroscopic region might be the outside perimeter, thereby automatically achieving an edge seal of the display during polymerization. The spacer elements may be porous structures, and the accelerator or photoinitiator is then allowed to absorb into the porous matrix in order to increase the weight percent of accelerator or photoinitiator in the desired localized region as well as to provide better interpenetration of the polymer and spacing, thus providing better adhesion. The spacer elements may be composed of glass, in the form of beads or rods, which are then etched to increase the surface area for improved adhesion. One or more layers of an adhesion promoter such as a silane coupling agent may be coated onto the glass spacers which may or may not have been etched, prior to coating of the glass spacers with the accelerator or photoinitiator. The spacer elements may be admixed to the photoinitiator or accelerator in concentrations higher than what would be desired in regions of the display that are active image areas. The mixture is then deposited onto the substrates via a printing or pipette method into the interpixel regions or the perimeter where no image is presented, thus providing additional support without adversely affecting the image contrast or quality. The initiator may be solely heat activated or heat activated as well as photo-activated or other activation method. The polymer is chosen so as to contract following initial bonding to the substrates and upon curing. The two substrates are thus drawn together, increasing durability of the display. This is particularly effective when the polymer is localized around the spacer element, as has been previously described. The spacer element may be one or more sheets of an extensible porous membrane that when laminated in between the substrates is the element that determines the spacing between the substrates.

In this and other embodiments, each substrate of the display device includes one or more panel substrates that may be made of glass or other rigid material.

In another embodiment, one or more non-structural PIE elements may have a thickness less than the size of the spacers. The non-structural PIE elements may not be in contact with more than one of the substrates and thus do not provide direct compressive structural support, and the photoinitiator, accelerator, or other polymerization enhancement material may be coated onto or contained within the non-structural PIE (NSPIE) elements.

Furthermore, the flexibility of the liquid crystal display may be rapidly decreased after attaching the polarizers in a method of manufacturing the LCD device. This is because the polarizers are respectively attached in whole to surfaces of the two substrates of the display panel, and the multi layers of the display panel and the polarizers are respectively fixed to each other. Accordingly, the rigidity of the multi layers of the LCD device is increased and the multi layers cannot relatively slide. To solve these problems, a method partially attaching the polarizers to the display panel is provided. However, the gaps between the polarizers and the display panel are ununiformed, and the characteristics of the LCD device are decreased.

To enhance the flexibility of the LCD device after attaching the polarizers to the display panel, a sealant is used to attach the polarizers to the display panel and spacers adhered to the polarizers to the display panel are used to maintenance the uniform gap between the polarizers and the display panel in the LCD device according to the present invention.

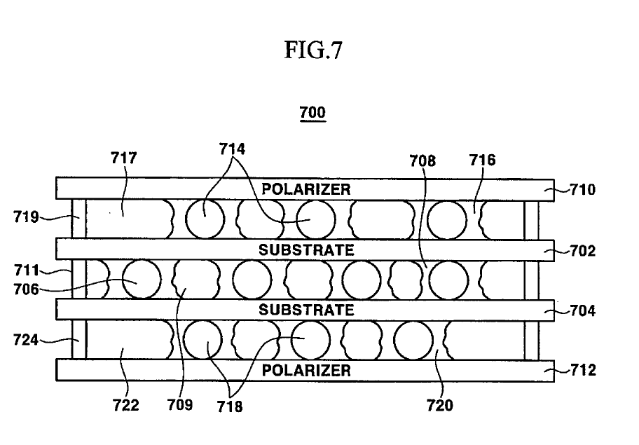

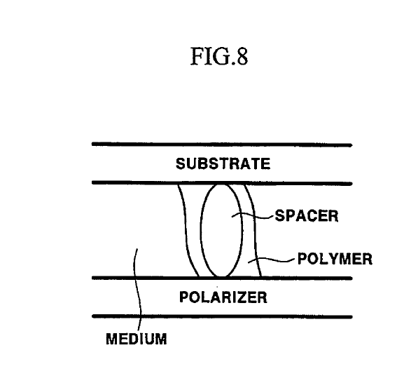

FIG. 7 shows a cross section of a liquid crystal display device with an adhesion of polarizers by using spherical spacers coated with polymer initiation, and FIG. 8 shows a cross section showing the transformation of spherical spacers coated with polymer initiation by shear stress in the liquid crystal display device.

Referring to FIG. 7, a display panel 700 of an LCD device according to an embodiment of the present invention includes first and second substrates 702 and 704 facing each other such as a TFT array substrate and a common electrode substrate, and a liquid crystal layer interposed between the first and second substrates 702 and 704. The liquid crystal layer changes the polarizer direction of the incidence light. A plurality of first spacers 706 are disposed to maintain a uniform gap between the first and second substrates. A first polymer 708 is formed at the surroundings of the first spherical spacers 706, and it fixes the positions between the two substrates and the spacers and provides flexibility against shear stress. The liquid crystal layer disposed between the first and second substrates 702 and 704 includes the first spacers 706 coated with the first polymer 708 and liquid crystal 709. The display panel 700 also includes a first sealant 711 to seal surrounding regions of the space between the first and second substrates 702 and 704 in which the first spacers 702, the first polymer 708 and the liquid crystal 709 are contained.

The display panel 700 of this embodiment also comprises two polarizers 710 and 712 respectively provided on outer surfaces of two substrates 702 and 704 such that the transmittance of the light passing through the two substrates 702 and 704 and the liquid crystal layer is controlled by the two polarizers 710 and 712. A plurality of second spherical spacers 714 are disposed between the first substrate 702 and the first polarizer 710 to maintain a uniform gap between the first substrate 702 and the first polarizer 710. The second spacers 714 have elasticity against external stress. The second spacers 714 are coated with second polymer 716 that fixes the positions between the first substrate 702 and the first polarizer 710 and provides flexibility against shear stress. A medium 717 is filled between the first substrate 702 and the first polarizer 710. The display panel 700 also includes a second sealant 719 to seal surrounding regions of the space between the first substrate 702 and the first polarizer 710 in which the second spacers 714, the second polymer 716 and the medium 717 are contained.

In like manner, a plurality of third spaces 718 are disposed between the second substrate 704 and the second polarizer 712 to maintain a uniform gap therebetween. The third spacers 718 are coated with third polymer 720 and elastic against external stress. The third polymer 720 fixes the positions between the second substrate 704 and the second polarizer 712 and provides flexibility against shear stress. A medium 722 is filled between the second substrate 704 and the second polarizer 712. The display panel 700 also includes a third sealant 724 to seal surrounding regions of the space between the second substrate 704 and the second polarizer 712 in which the third spacers 718, the third polymer 720 and the medium 722 are contained.

In this embodiment, the second and third spacers 714 and 718 and the second and third polymers 716 and 720 may uniformly maintain the gap between the first substrate 702 and the first polarizer 710 and the second substrate 704 and the second polarizer 712, as described above, with a bend condition of the LCD device, and moiré phenomenon can be removed. Furthermore, the second and third polymers 716 and 720 fix the positions of the substrates 702 and 704 and the polarizers 710 and 712 to prevent the gap between the first substrate 702 and the first polarizer 710 and between the second substrate 704 and the second polarizer 712 from being widened when the interlayer interval is widened. Also, the second and third polymers 716 and 720 provide the flexibility against shear stress from left and right directions as shown in FIG. 8. The second and third spacers 714 and 718 and the second and third polymers 716 and 720 may or may not be the same materials as those of the first spacers 706 and the first polymer 708, respectively.

In the method for manufacturing the LCD device according to the present invention, the process for forming the second polymer may be identically and/or simultaneously executed with the process of formation of the first polymer. The third polymer may also be formed identically and/or simultaneously with the formation of the first polymer.

The structure and method attaching the polarizers to the substrates by using the spacers, polymer and sealant according to the present invention may apply to the method for manufacturing an LCD device that does not include a polymer between the substrates. The polymer may be made of a material suitable for ultraviolet irradiation or thermal radiation.

The display device of present invention may be advantageously driven using a relatively low drive voltage. In addition, it is not necessary that the complicated process using photo-mask be executed to manufacture a display device, and the method for manufacturing a display device according to the present invention is compatible with the method for manufacturing a liquid crystal display device. In the display device of the present invention, peel and shear strength and compressive strength by the spacers are provided.

Due to the fact that spacer elements between substrates may not have an index of refraction identical to that of the liquid crystal and polymer mixture, the spacer elements may cause scattering of light when the display is illuminated, thus resulting in a ‘haziness’ and reduced contrast if the spacer density is too high. The present invention provides the additional polymerization initiation sites while only minimally degrading the contrast in the process.

Non-structural PIE's provide the significant benefit of additional polymer interconnections between the substrates resulting in added peel strength but with relatively little impact on compressive strength. By adjusting the relative densities of the spacers and the non-structural PIE's, improvements in compressive and peel strengths of the display device's laminate structure can be achieved.

Furthermore, the polarizers may be attached to the substrates with good flexibility and omission of adhesion area to attach the polarizers by using the polymer and the spacers supporting and fixing the polarizers, and sealant. The manufacturing method may be simplified by enhancing adhesion strength of the polarizer with the polymer with omission of additional process.

While the present invention has been described in detail with reference to the preferred embodiments, those skilled in the art will appreciate that various modifications and substitutions can be made thereto without departing from the spirit and scope of the present invention as set forth in the appended claims.

1. A display device for displaying images, comprising:
two substrates facing each other and having a predetermined gap therebetween;
field-generating electrodes forming an electric field between the two substrates;
first spacers disposed between the two substrates to allow the two substrates to have the predetermined gap therebetween;
a liquid crystal layer disposed between the two substrates;
a polarizer disposed on an outer surface of at least one of the two substrates; and
second spacers disposed between the polarizer and the at least one of the two substrates to allow the polarizer and the at least one of the two substrates to have a uniform gap therebetween.

2. The display device of claim 1, wherein the first and the second spacers are spherical.

3. The display device of claim 1, wherein the first and second spacers have a column shape.

4. The display device of claim 1, wherein the first and the second spacers have elasticity.

5. The display device of claim 1, wherein the first and second spacers are made of material including plastic.

6. The display device of claim 1, wherein the first and second spacers comprise particles having one of nanoporous surface, mesoporous surface and microporous surface.

7. The display device of claim 1, further comprising a first polymer disposed around the first spacers between the two substrates, the first polymer providing adhesion between the two substrates.

8. The display device of claim 1, further comprising a second polymer disposed around the second spacers between the polarizer and the at least one of the two substrates, the second polymer providing adhesion between the polarizer and the at least one of the two substrates.

9. The display device of claim 1, further comprising a medium disposed between the polarizer and the at least one of the two substrates.

10. The display device of claim 9, further comprising a sealant to seal surrounding regions of a space between the polarizer and the at least one of the two substrates, wherein the second spacers, the second polymer and the medium are contained in the space.

11. A method of manufacturing a display panel of an image display device, comprising:
providing two substrates having field-generating electrodes to form an electric field between the two substrates;
coating spacers with initiator material that initiates polymerization reaction;
disposing the spacers between the two substrates;
disposing liquid crystal and pre-polymer mixture between the two substrates; and
laminating the two substrates together, the two substrates having a gap therebetween by means of the spacers.

12. The method of claim 11, wherein the providing the two substrates includes:
providing two panel substrates having flexible polymer material;
forming a conductor layer on each of the two panel substrates; and
forming a polyimide alignment layer on the conductor layer, wherein the spacers and the liquid crystal and pre-polymer mixture are disposed between polyimide alignment layers of the two substrates.

13. The method of claim 12, further including forming a polarizer on an outer surface of at least one of the two panel substrates.

14. The method of claim 11, further including exposing the laminated substrates to ultraviolet light when the initiator material includes photoinitiator.

15. The method of claim 11, wherein the coating the spacers with the initiator material includes adding accelerant in the initiator material.

16. The method of claim 15, wherein the accelerant is accelerator lacquer initiator.

17. The method of claim 11, wherein the disposing the liquid crystal and pre-polymer mixture includes adding polymer initiation or enhancement (PIE) elements to activate a polymerization reaction.

18. The method of claim 11, wherein the coating the spacers with the initiator material includes adding silane to the initiator material.

19. The method of claim 11, wherein the disposing the liquid crystal and pre-polymer mixture includes adding acrylic adhesives to the liquid crystal and pre-polymer mixture.

20. The method of claim 11, wherein the disposing the liquid crystal and pre-polymer mixture includes modifying the pre-polymer to remove photoinitiator from the pre-polymer.
